(19) United States
(12) Patent Application Publication
(10) Pub. No.: US 2011/0163938 A1
(43) Pub. Date: Jul. 7, 2011

(54) CIRCUIT ELEMENT

(76) Inventor: Tamotsu Iida, Osaka (JP)

(21) Appl. No.: 13/063,025

(22) PCT Filed: Nov. 5, 2009
(86) PCT No.: PCT/JP2009/068892

§ 371 Date: Mar. 9, 2011

(30) Foreign Application Priority Data
Nov. 5, 2008 (JP) 2008-283994

(51) Int. Cl. H01Q 1/50

(52) U.S. Cl. 343/906

(57) ABSTRACT

A circuit element 1 according to the present invention has a first element 2 and a second element 3 that are stacked, with a conductor 5 of the first element 2 contacting a conductor 7 of the second element 3. Contact portions 9 are arranged such that the interval of a gap between adjacent contact portions 9 is less than or equal to one-quarter of a propagation wavelength of an electromagnetic wave. Such a configuration eliminates adverse effects due to electromagnetic waves, leaking into the interval portion between adjacent contact portions, and enables stable function formation.

### TECHNICAL FIELD

The present invention relates to a circuit element constituted by a plurality of laminated elements.

### BACKGROUND ART

High-frequency elements require high-precision manufacturing techniques with shortening of the design wavelength. The use of millimeter waves has been proposed in order to perform wireless transmission of hi-vision video without compressing, and a wireless HD standard was substantially defined as a global standard by IEEE802.15.3c in January 2008.

By way of background, the 60 GHz band of the millimeter wave range has been allocated internationally to specified low power radio which does not require a radio station license, and dissemination and provision for consumer applications is nearing completion.

Wavelength is about 5 mm at high frequencies such as millimeter waves, and the dimensions of filters and antennas need to be accurate to the micrometer. In particular, with array antennas formed by arraying a large number of antenna elements such as antennas so that the reception signals are phase-synthesized, it is important to control the phase and gain of individual elements. For this reason, the arrangement and size of antenna elements must be accurately controlled. The elements themselves are very small, and will not function adequately as an array antenna if precision is not maintained.

The development of multifunction devices, including millimeter wave antennas, has stepped up a level. The millimeter wave band centered on 60 GHz is suitable for broadband transmission and short range communication, and can be used without a license under the Radio Act. The framework for utilizing this region globally is being established.

Meanwhile, in place of conventional GaAs elements serving as millimeter-wave active elements, development of chips using an inexpensive SiCMOS (Si Complementary Metal Oxide Semiconductor) process as millimeter-wave elements is progressing.

With millimeter wave elements, dielectric loss, conductor loss (copper loss) and radiation loss, which were relatively unproblematic in the microwave range, increase in the millimeter wave range, thus requiring that the state of interfaces between dielectric materials and conductors and the properties of the various materials be examined in terms of loss.

Depending on the manufacturing method, a situation can arise in which elements that adequately satisfy the characteristics of a millimeter wave device cannot be acquired due to the necessary precision and uniformity not being acquired. Manufacturing methods also change depending on the selection of materials, with a change in manufacturing method possibly leading to a change in manufacturing precision, and also effecting mass production efficiency and yield.

Given such a background, manufacturing methods for millimeter wave elements have been proposed that have a mass production efficiency suitable for consumer use and high characteristic yield (Patent Documents 1 to 3).

A circuit element can be constituted by fitting a millimeter wave device manufactured using such a method into a metal antenna adapter 120 as an antenna 130, such as shown in FIGS. 5 and 8. In other words, a fitting portion 121 for the antenna 130 to be fitted into is formed in the antenna adapter 120. Further, a propagation path 122 of electromagnetic waves is formed in the antenna adapter 120 so as to be adjacent to the fitting portion 121. The antenna 130 is fitted into the fitting portion 121 of the antenna adapter 120. The antenna 130 is constituted by covering a dielectric substrate 140 with a conductor (conductive film) 150, with a circuit pattern formed in a prescribed position exposed on the surface, as shown in FIG. 6.

Also, a sophisticated circuit element can be constituted by stacking a plurality of elements having a dielectric substrate on which a circuit pattern is formed. In other words, as shown in FIG. 9, a first element 2 in which an area of a dielectric substrate 4 other than a circuit pattern is covered with a conductor 5 and a second element 3 in which an area of a dielectric substrate 6 other than a circuit pattern is similarly covered with a conductor 7 are stacked to form a circuit element.

Incidentally, multilayer substrates are disclosed in Patent Documents 4 and 5.

### PRIOR ART DOCUMENTS

### Patent Documents

Patent Document 1: JP 2003-115718A
Patent Document 2: JP 2004-15833A
Patent Document 3: JP 2004-48801A
Patent Document 4: JP 2002-305366A
Patent Document 5: JP 10-27987A

### DISCLOSURE OF INVENTION

### Problem to be Solved by the Invention

When a circuit element is constituted as shown in FIGS. 5 and 8, electrical gaps arise between the lower surface of the antenna 130 and the bottom face of the fitting portion 121 of the antenna adapter 120, as shown in FIG. 10, which is an enlarged view of the areas in FIGS. 5 and 8 enclosed with broken lines. Similarly, electrical gaps such as shown in FIG. 9 arise, when the first element 2 and the second element 3 having circuit patterns are stacked. In other words, the elements end up warped or wavy, even when manufactured with high precision using the manufacturing methods of the above Patent Documents 1 to 3. Thus, gaps (non-contact portions) 8 arise when the circuit element is constituted. When the length of these non-contact portions 8, that is, an interval a orb between adjacent contact portions 9, is greater than one-quarter of the propagation wavelength of an electromagnetic wave, the non-contact portions 8 function as circuits, resulting in a loss of output and different circuit functions.

The present invention has as its object to provide a circuit element that eliminates adverse effects due to electromagnetic waves leaking into the non-contact portions, and enables stable function formation.

### Means for Solving Problem

A circuit element according to the present invention has a first element and a second element that are stacked, with a conductor of the first element contacting a conductor of the second element. The contact portions are arranged such that the interval of a gap between the contact portions that are adjacent is less than or equal to one-quarter of a propagation wavelength of an electromagnetic wave. Such a configuration eliminates adverse effects due to electromagnetic waves leaking into the interval portion between adjacent contact portions, and enables stable function formation.

Preferably, a raised portion or a recessed portion is formed with respect to one or both of the first and second elements, and the raised portion contacts the other element.

Preferably, a raised portion is formed on the first element and a recessed portion is formed in the second element at a position corresponding to the raised portion of the first element, with the raised portion fitted into and contacting the recessed portion.

Preferably, the first element is a metal antenna adapter, and the second element is an antenna having a dielectric substrate that is covered with a conductor, with the antenna being fitted into a fitting portion formed in the antenna adapter, and an end face of a raised portion formed on a lower surface of the antenna contacting a bottom face of the fitting portion of the antenna adapter.

Preferably, a propagation path for an electromagnetic wave is formed in the antenna adapter so as to be adjacent to the fitting portion, and the raised portion of the antenna is disposed in a region adjacent to the propagation path when the antenna is fitted into the fitting portion formed in the antenna adapter. Such a configuration enables the step of forming raised portion to be simplified.

Preferably, the circuit element is constituted by stacked circuits that are formed using a molding technique.

### Effects of the Invention

The present invention eliminates adverse effects due to electromagnetic waves leaking into a non-contact portion, and enables stable function formation.

### BRIEF DESCRIPTION OF DRAWINGS

FIG. 1 is an enlarged schematic perspective view of a circuit element of Embodiment 1 of the present invention.

FIG. 2 is a plan view schematically showing an arrangement of raised portions and recessed portions in the circuit element of Embodiment 1 of the present invention.

FIG. 3 is an enlarged schematic perspective view of a circuit element of Embodiment 2 of the present invention.

FIG. 4 is a plan view schematically showing an arrangement of raised portions and recessed portions in the circuit element of Embodiment 2 of the present invention.

FIG. 5 is a cross-sectional view schematically showing an exemplary antenna configuration of an embodiment of the present invention.

FIG. 6 is a perspective view schematically showing a slot antenna.

FIG. 7 is a diagram for describing an area of the slot antenna in which raised portions are formed.

FIG. 8 is a cross-sectional view schematically showing an exemplary antenna configuration of an embodiment of the present invention.

FIG. 9 is an enlarged schematic perspective view of a state in which planar circuit elements are stacked.

FIG. 10 is an enlarged perspective view of a portion of FIG. 5 enclosed with a broken line.

### DESCRIPTION OF THE INVENTION

Firstly, an overview of a circuit element according to the present invention will be described, after which embodiments will be described in detail.

A circuit element according to the present invention is constituted by a plurality of laminated elements, a first element and a second element of which are stacked with a conductor of the first element contacting a conductor of the second element, and the contact portions being arranged such that an interval of a gap between adjacent contact portions is less than or equal to one-quarter of a propagation wavelength of an electromagnetic wave. For example, when sheets (dielectric substrates) having circuit patterns formed thereon are combined to constitute a module, a configuration is adopted in which conductors provided on the sheets at ground potential are provided with contact portions at an interval less than or equal to one-quarter of the propagation wavelength of an electromagnetic wave, using raised portions or recessed portions provided with respect to the sheets.

Bringing the conductors provided on the sheets into contact uniformly without a gap is difficult. Thus, when the interval between adjacent contact portions reaches a length that allows the propagation wavelength of electromagnetic waves to pass through, electromagnetic waves leak into the non-contact portions, and the circuit element operates as a circuit in which gap circuits have been inserted. These gap circuits are unintended, and end up impairing the original functions of the circuit element. According to the present invention, conductor contact points are provided at intervals of less than or equal to one-quarter of the propagation wavelength, which are intervals into which electromagnetic waves will not leak, with the aim of preventing the occurrence of such unintended circuits.

Pattern molding is advantageous in that dimensions and positions can be accurately transferred, and is characterized by a high yield in production of circuit elements having a short wavelength such as millimeter waves. The planar surfaces of molded substrates or sheets are required to be uniformly flat, although particularly in the case where molded substrates or sheets are stacked to constitute a module, it is difficult to provide a circuit configuration while taking the mutual contact surfaces into consideration. The present invention solves this problem, and enables provision of a circuit configuration that takes the mutual contact surfaces into consideration by specifying contact surfaces and contact points, when molded substrates or sheets are stacked, even when the molded substrates or sheets do not necessarily have flatness. Thus, the occurrence of an unintended circuit configuration can be prevented, and a circuit element can be constituted with which stable operation can be anticipated.

Even in the case where molded substrates or sheets are not flat, when constituting a multifunction module by stacking molded substrates or sheets on which circuit patterns are formed, raised portions or recessed portions are formed with respect to the contact surface side of the molded substrates or sheets and brought into contact, such that the length of a non-contact portion is not greater than one quarter of λ(λ=propagation wavelength of electromagnetic wave), which has an important function as a circuit. This enables flexible assembly by ensuring contact points of a ground pattern for forming a circuit element capable of being combined independently of warpage or waviness of the molded substrates or sheets.

Note that the molded substrates or sheets could also be constituted by metal structures which are conductors.

### Embodiment 1

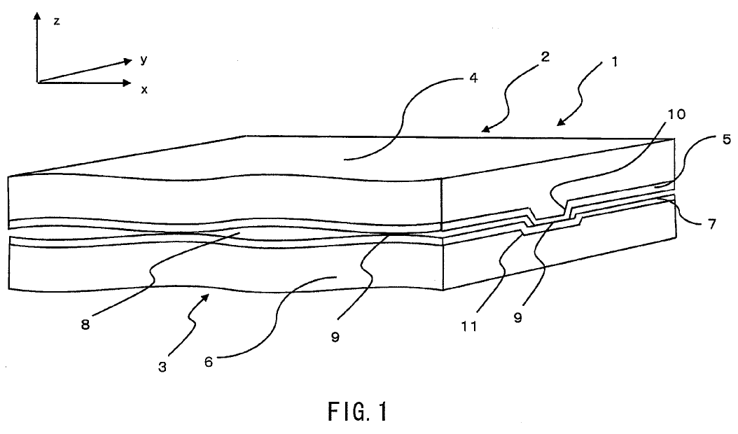

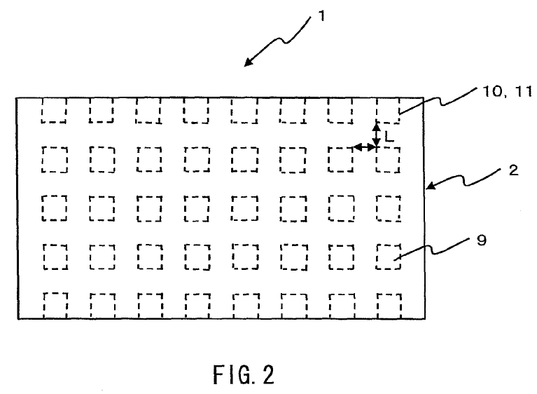

Embodiment 1 of a circuit element according to the present invention will be described based on FIGS. 1 and 2.

A circuit element 1 of the present embodiment is used in the millimeter wave range. A first element 2 and a second element 3 constituting the circuit element 1 are manufactured with a printed circuit board fabrication process, which is a conventional technique.

The process will be outlined. A photoresist is applied to a dielectric substrate on which a predesigned circuit pattern has been copper clad, and the applied photoresist is exposed to light. The exposed photoresist is developed, and the copper exposed through the photoresist is etched while leaving the resist on the circuit pattern, thereby forming a pattern.

The etching is performed using ferric oxide, with agitation during the etching and management of the etching solution being important, since the etching speed changes depending on the temperature and density of the etching solution and the etching time. The immersion time in the etching solution ultimately determines the amount of etching.

The dimensions of the pattern are, strictly speaking, influenced not only by the resist coat but also by the above-mentioned etching conditions. Accordingly, fabricating the pattern dimensions uniformly with high yield is difficult with patterns covering a large area.

Antennas in the millimeter wave range are often fabricated by arraying patch antennas on a Teflon (registered trademark) substrate. However, the precision of the elements of the array antenna is important as mentioned above, and the fact that yields cannot be achieved with circuit patterns in the short-wavelength millimeter wave range when circuit elements are made with a large area has been a problem. Also, mass productivity has been a problem due to the difficulty of forming a large number of elements at once because of the limits of large-area etching. Teflon (registered trademark) substrates are generally expensive and have low mass productivity and thus the production cost is raised if the yield is low.

In the case of constituting a pattern as a circuit element, such as in the case of realizing a filter or a coaxial structure using a microstrip line, for example, a configuration is often adopted in which a circuit pattern on the front surface is paired with a ground plane of the back surface. While the microstrip line is constituted by ground on the back surface, a circuit pattern on the front surface, and a dielectric substrate therebetween, microstrip lines are also often designed with the ground plane provided on the front surface. Given that the ground pattern and the ground plane constitute a circuit, the ground pattern on the front surface and the ground plane on the back surface need to be electrically connected.

Note that manufacturing methods using nanoimprinting or injection molding are known as techniques for creating highly accurate circuit patterns and acquiring mass productivity. In other words, a dielectric substrate on which a circuit pattern is formed in a prescribed position is manufactured using a molding tool for molding circuit patterns.

A dielectric substrate 4 manufactured as described above is covered with a conductor 5 to form the first element 2, a dielectric substrate 6 is similarly covered with a conductor 7 to form the second element 3, and the first element 2 and the second element 3 are stacked with the conductor 5 contacting the conductor 7 to form the circuit element 1 (circuit is omitted).

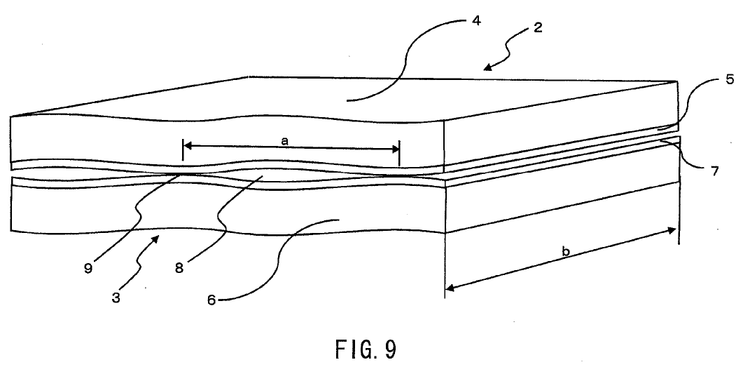

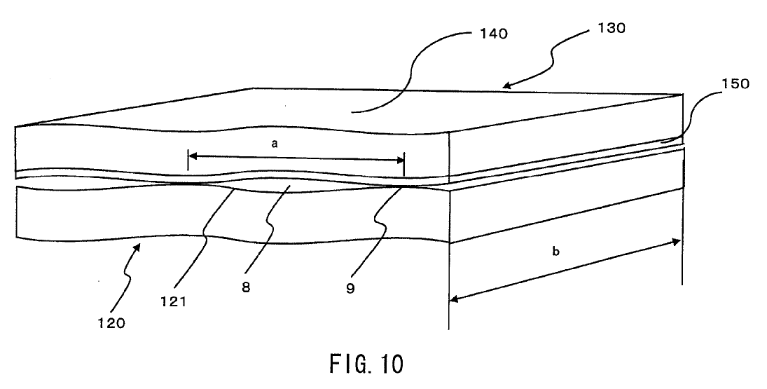

The dielectric substrates 4 and 6 are warped or have wavy surfaces. The amount of warpage or waviness is typically greater than the thickness of the conductors 5 and 7. Thus, appropriate pressure needs to be applied in order to bring the dielectric substrates 4 and 6 into close contact. However, an electrically non-contact portion (contactless interval) 8 arises even when the conductors 5 and 7 are in partial contact. When this non-contact portion 8 reaches a considerable length relative to the propagation wavelength of an electromagnetic wave such as shown in FIG. 9, a circuit is formed in which electromagnetic waves leak into this non-contact portion 8. In this case, anticipated circuit operation cannot be realized since the resultant circuit operates differently from the intended circuit.

The circuit resulting from this non-contact portion 8 can be eliminated if the interval between adjacent contact portions 9 is less than or equal to one-quarter of λ. The interval between adjacent contact portions 9 needs to satisfy the above relation in the xy coordinates in FIG. 1. If the interval between adjacent contact portions 9 in FIG. 1 is longer than one-quarter of λ, measures are needed to shorten the length of the interval.

Thus, with the circuit element of the present invention, the contact portions 9 between the conductors 5 and 7 are arranged such that the interval of the gap between adjacent contact portions 9 is greater than 0 times λ and less than or equal to one-quarter of λ, as shown in FIG. 1. The contact portions 9, whether they be points or surfaces, desirably are in stable contact, and an intentional contact structure is sought for this purpose.

In the present embodiment, a pattern of dot-like raised portions 10 is formed on the dielectric substrate 4, and the conductor 5 is formed so as to cover this pattern, thus constituting the first element 2. These raised portions 10, when viewed in plan, are arranged in a regular manner as shown in FIG. 2. In this case, an interval L between adjacent raised portions 10 is set to be less than or equal to one-quarter of λ. On the other hand, a pattern of recessed portions 11 is formed on the dielectric substrate 6, and the conductor 7 is formed so as to cover this pattern, thus constituting the second element 3. These recessed portions 11 are arranged so as to correspond to the raised portions 10. The raised portions 10 of the first element 2 and the recessed portions 11 of the second element 3 are fitted together, with the conductor 5 formed on the end faces of the raised portions 10 being in contact with the conductor 7 formed on the bottom faces of the recessed portions 11. As a result, the contact portions 9 are, as shown in FIG. 2, arranged in a regular manner such that the interval L between adjacent contact portions 9 will be less than or equal to one-quarter of λ, without being affected by the warpage or waviness of the dielectric substrates 4 and 6.

That is, contact between the surfaces results in irregular intervals between electrical connection points, and destabilizes the formation of gap circuits. Since the gap between conductors, that is, the length that affects electromagnetic waves has wavelength dependency, a length that does not affect the wavelength of electromagnetic waves needs to be set. The functioning of the gaps as gap circuits can be restricted, since the penetration of electromagnetic waves into these gaps can be inhibited if the length of the opening of the gaps is less than or equal to one-quarter of the wavelength of the electromagnetic waves. Thus, a structure needs to be provided that is designed to reliably ensure that the length of the opening of the gaps is less than or equal to one-quarter of the wavelength of the electromagnetic waves, and the contact length of the surfaces can be specified by providing raised forms on one or both of the surfaces in order to ensure contact points between the surfaces.

When raised portions are provided on a wavy surface, it is the raised portions that first come into contact with the opposing surface. Accordingly, a state where contact between the surfaces results in irregular intervals between electrical contact points can be avoided, and the other contact portions also help to ensure the preset distance between the raised portions. While reliable contact between the surfaces can be anticipated if the height of the raised portions is greater than or equal to the height of the waves, setting the raised portions to be higher than the amount of waviness is effective when taking the amount of waviness on the target surface into consideration. In the case where the surface is a non-rigid form such as a sheet, the contact of the raised portions can be ensured by applying surface contact pressure.

In any case, the provision of contact points such that the interval of the gaps is a specific length by providing raised portions enables the effect of being able to provide contact points such that the interval of gaps is less than or equal to a specific length to be anticipated in the case where raised portions are provided on both contacting surfaces.

Given the above, the electrical length formed by the interval of the gaps can be set to less than or equal to one-quarter of the wavelength of the electromagnetic waves, and the occurrence of unintended stub circuits or notch circuits can be inhibited.

The interval between adjacent contact portions 9 can thus be shortened while at the same time realizing a stable coupling between conductors by fitting the raised portions 10 into the recessed portions 11. Thus, adverse effects due to electromagnetic waves leaking into non-contact portions 8 are eliminated, and stable function formation is enabled.

Incidentally, the use of nanoimprinting or injection molding as the molding method of the dielectric substrates 4 and 6 enables the raised portions 10 or the recessed portions 11 to be formed collectively in the same molding step. Thus, the raised portions 10 and the recessed portions 11 can be formed easily in prescribed positions with high accuracy.

Note that the planar shape and the cross-sectional shape of the raised portions 10 and the recessed portions 11 are not limited to being square-shaped as shown in FIG. 1, and may have another polygonal shape or a circular shape. Also, the height of the raised portions 10 and the depth of the recessed portions 11 can be set such that favorable contact is achieved when the raised portions 10 are fitted into the recessed portions 11. Moreover, the raised portions 10 and the recessed portions 11 need not be arranged in a regular manner, and may be arranged in an irregular manner. Further, the raised portions 10 and the recessed portions 11 are not limited to being dot-like, and may be continuous. Also, recessed portions may be formed in the first element 2 and raised portions may be formed on the second element 3. In short, the raised portions 10 and the recessed portions 11 can be formed in order to form the contact portions 9 such that the interval L between adjacent contact portions 9 is less than or equal to one-quarter of λ.

### Embodiment 2

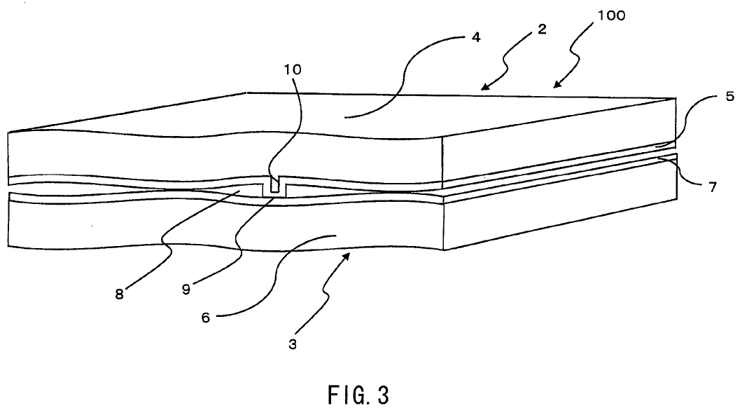

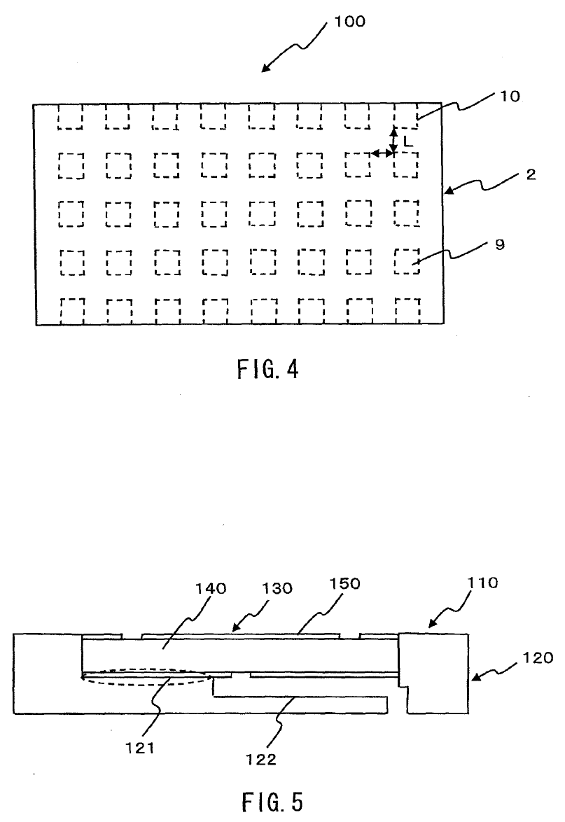

Embodiment 2 of a circuit element according to the present invention will be described based on FIGS. 3 and 4.

A circuit element 100 according to the present embodiment is assumed to have a substantially similar configuration to the circuit element 1 of the above embodiment, except that the recessed portions 11 of the second element 3 are omitted. In this case also, the contact portions 9 are arranged such that the interval L between adjacent contact portions 9 will be less than or equal to one-quarter of λ, without being affected by warpage or waviness of the dielectric substrates 4 and 6. In other words, the conductor 5 formed on the end faces of the raised portions 10 of the first element 2 contacts the conductor 7 of the second element 3, enabling the length of the non-contact portions 8 to be shortened. Thus, adverse effects due to electromagnetic waves leaking into the non-contact portions 8 can be eliminated, enabling stable function formation.

Similarly in the present embodiment, the use of nanoimprinting or injection molding as the molding method of the dielectric substrate 4 enables the raised portions 10 to be formed collectively in the same molding step. Thus, the raised portions 10 can be formed easily in prescribed positions with high accuracy.

Note that the planar shape and the cross-sectional shape of the raised portions 10 are not limited to being square-shaped, and may have another polygonal shape or a circular shape. The height of the raised portions 10 is also set appropriately. Moreover, the raised portions 10 need not be arranged in a regular manner, and may be arranged in an irregular manner. Further, the raised portions 10 are not limited to being dot-like, and may be continuous. In short, the raised portions 10 can be formed in order to form the contact portions 9 such that the interval between adjacent contact portions 9 is less than or equal to one-quarter of λ.

### Embodiment 3

Embodiment 3 of the circuit element according to the present invention will be described based on FIGS. 5 through 8.

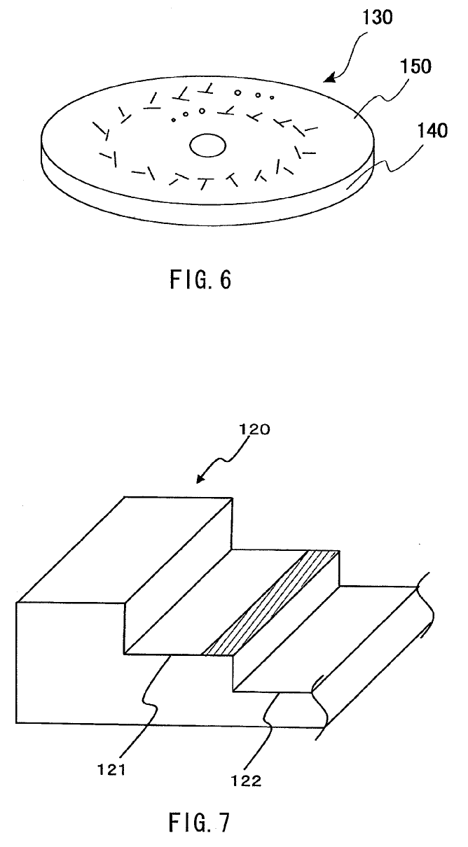

A circuit element 110 of the present embodiment is constituted as a planar antenna used in the millimeter wave range, for example. With this circuit element 110, a first element 120 is a metal antenna adapter (hereinafter, the same numerals as the first element will be given), as shown in FIG. 5, and a second element 130 is a slot antenna (hereinafter, the same numerals as the second element will be given), as shown in FIG. 6. A fitting portion 121 into which the second element 130 is fitted is formed in the first element 120. Further, a propagation path 122 of electromagnetic waves to be fed to the slot antenna 130 is formed in the antenna adapter 120, so as to be adjacent to the fitting portion 121. With the slot antenna 130, a plastic dielectric substrate 140 is covered with a conductor 150, and a circuit pattern formed in a prescribed position is exposed on the surface. When fitted together, an electrical gap occurs in the contact portions between the antenna adapter 120 and the slot antenna 130 in the region shown by the broken line in FIG. 5 as described above. Thus, in the present embodiment, a configuration is adopted in which raised portions are formed on portions of the slot antenna 130 that oppose the bottom face of the fitting portion 121 of the antenna adapter 120, and electromagnetic waves are prevented from leaking from the propagation path 122 into the gap between the bottom face of the fitting portion 121 of the antenna adapter 120 and the lower surface of the slot antenna 130. Apart from raised portions being implemented with respect to the entire fitting portion, raised portions may be formed only on the region adjacent to the propagation path 122 of the fitting portion 121, which serves as the penetration path of electromagnetic waves, that is, only in the region corresponding to the shaded portion shown in FIG. 7. The regions on which to provide raised portions can be determined appropriately. Note that the shape and arrangement of the raised portions can be set appropriately such that the interval between adjacent contact portions is less than or equal to one-quarter of λ, similarly to Embodiments 1 and 2.

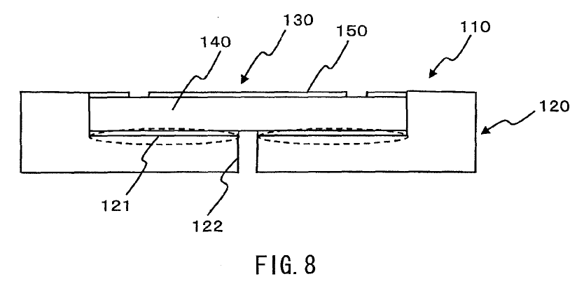

In the present embodiment, a configuration is adopted in which the propagation path 122 of the antenna adapter 120 utilizes the conductor of the slot antenna 130, but the present invention can be similarly embodied even when a configuration is adopted in which the conductor of the slot antenna 130 is not utilized such as shown in FIG. 8. Even in this case, raised portions need only be formed in regions of the slot antenna 130 that are adjacent to the propagation path 122.

In the present embodiment, the raised portions are formed on the slot antenna 130, but the raised portions may be formed on the antenna adapter 120. Also, a configuration may be adopted in which recessed portions are formed in the antenna adapter 120, and raised portions on the slot antenna 130 are fitted into the recessed portions.

While circuit elements according to the present invention has been described hereinabove, variations that do not depart from the gist of the invention are intended to be within the scope of the invention.

### INDUSTRIAL APPLICABILITY

The importance of solving the problem of the gap that arises, in the case of fabricating a circuit element for realizing functionality by stacking sheets (substrates), when the sheets (substrates) are stacked in order to realize a consistent coupling between the sheets (substrates) was described, and countermeasures were shown. This method is effective not only for sheets (substrates) but also in the case of constituting a circuit by bringing metal surfaces into contact with each other. Stable operation can be anticipated by eliminating gap circuits.

### EXPLANATION OF LETTERS OR NUMERALS

1 Circuit element
2 First element
3 Second element
4, 6 Dielectric substrate
5, 7 Conductor
8 Non-contact portion
9 Contact portion
10 Raised portion
11 Recessed portion
100, 110 Circuit element
120 Antenna adapter
121 Fitting portion
122 Propagation path
130 (Slot) Antenna
140 Dielectric Substrate
150 Conductor
a, b, L Interval between adjacent contact portions

1. A circuit element comprising a plurality of laminated elements, a first element and a second element of which are stacked with a conductor of the first element contacting a conductor of the second element,
wherein the contact portions are arranged such that an interval of a gap between the contact portions that are adjacent is less than or equal to one-quarter of a propagation wavelength of an electromagnetic wave.

2. The circuit element according to claim 1, wherein a raised portion or a recessed portion is formed with respect to one or both of the first and second elements, and the raised portion contacts the other element.

3. The circuit element according to claim 1,
wherein a raised portion is formed on the first element and a recessed portion is formed in the second element at a position corresponding to the raised portion of the first element, and
the raised portion is fitted into and contacts the recessed portion.

4. The circuit element according to claim 1,
wherein the first element is a metal antenna adapter, and the second element is an antenna having a dielectric substrate that is covered with a conductor, and
the antenna is fitted into a fitting portion formed in the antenna adapter, and an end face of a raised portion formed on a lower surface of the antenna contacts a bottom face of the fitting portion of the antenna adapter.

5. The circuit element according to claim 4,
wherein a propagation path for an electromagnetic wave is formed in the antenna adapter so as to be adjacent to the fitting portion, and
the raised portion of the antenna is disposed in a region adjacent to the propagation path when the antenna is fitted into the fitting portion Banned in the antenna adapter.

6. The circuit element according to claim 1, comprising stacked circuits that are formed using a molding technique.

7. The circuit element according to claim 2,
wherein the first element is a metal antenna adapter, and the second element is an antenna having a dielectric substrate that is covered with a conductor, and
the antenna is fitted into a fitting portion formed in the antenna adapter, and an end face of a raised portion formed on a lower surface of the antenna contacts a bottom face of the fitting portion of the antenna adapter.

8. The circuit element according to claim 3,
wherein the first element is a metal antenna adapter, and the second element is an antenna having a dielectric substrate that is covered with a conductor, and
the antenna is fitted into a fitting portion formed in the antenna adapter, and an end face of a raised portion formed on a lower surface of the antenna contacts a bottom face of the fitting portion of the antenna adapter.

9. The circuit element according to claim 7,
wherein a propagation path for an electromagnetic wave is formed in the antenna adapter so as to be adjacent to the fitting portion, and
the raised portion of the antenna is disposed in a region adjacent to the propagation path when the antenna is fitted into the fitting portion formed in the antenna adapter.

10. The circuit element according to claim 8,
wherein a propagation path for an electromagnetic wave is formed in the antenna adapter so as to be adjacent to the fitting portion, and
the raised portion of the antenna is disposed in a region adjacent to the propagation path when the antenna is fitted into the fitting portion formed in the antenna adapter.

11. The circuit element according to claim 2, comprising stacked circuits that are formed using a molding technique.

12. The circuit element according to claim 3, comprising stacked circuits that are formed using a molding technique.
